(19) United States
(12) Patent Application Publication
(10) Pub. No.: US 2025/0220555 A1
(43) Pub. Date: Jul. 3, 2025

(54) METHOD AND DEVICE FOR CONTROLLING NETWORK SLICE ACCESS IN WIRELESS COMMUNICATION SYSTEM

(71) Applicant: Samsung Electronics Co., Ltd., Gyeonggi-do (KR)

(72) Inventors: Dongeun SUH, Gyeonggi-do (KR); Jungshin PARK, Gyeonggi-do (KR)

(21) Appl. No.: 19/007,994

(22) Filed: Jan. 2, 2025

(30) Foreign Application Priority Data
Jan. 2, 2024 (KR) 10-2024-0000531

(51) Int. Cl. H04W 48/08

(52) U.S. Cl. CPC H04W 48/08

(57) ABSTRACT

The disclosure relates to a 5G or 6G communication system for supporting a higher data transmission rate. The present disclosure provides a method performed by a network function (NF) for network slice access control in a wireless communication system. The method includes transmitting, to a network slice admission control function (NSACF), an event exposure subscribe message including information about a status of single network slice selection assistance information (S-NSSAI), receiving, from the NSACF, an event exposure subscribe response message indicating the result about subscription, receiving, from the NSACF, an event exposure notify message including information about event information.

### CROSS-REFERENCE TO RELATED APPLICATION(S)

This application is based on and claims priority under 35 U.S.C. § 119 to Korean Patent Application No. 10-2024-0000531, which was filed in the Korean Intellectual Property Office on Jan. 2, 2024, the entire content of which is incorporated herein by reference.

### BACKGROUND

### 1. Field

The disclosure relates generally to a wireless communication system, and more particularly, to a method and device for network slice access in a wireless communication system.

### 2. Description of Related Art

5G mobile communication technologies define broad frequency bands such that high transmission rates and new services are possible, and can be implemented not only in “Sub 6 GHz” bands such as 3.5 GHZ, but also in “Above 6 GHz” bands referred to as mm Wave including 28 GHz and 39 GHz. In addition, it has been considered to implement 6G mobile communication technologies (referred to as Beyond 5G systems) in terahertz bands (for example, 95 GHz to 3 THz bands) to accomplish transmission rates fifty times faster than 5G mobile communication technologies and ultra-low latencies one-tenth of 5G mobile communication technologies.

At the beginning of the development of 5G mobile communication technologies, to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as an LDPC (Low Density Parity Check) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR user equipment (UE) Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

The 3rd generation partnership project (3GPP), which controls cellular mobile communication standardization, has named the new CN structure 5G core (5GC) and standardized the 5GC to promote the evolution from the legacy 4G LTE system to the 5G system. 5GC supports the following differentiated functions as compared to the evolved packet core (EPC), which is the legacy network core for 4G.

5GC adopts the network slicing function. As a requirement of the 5G system, 5GC may support various types of terminals and services, e.g., eMBB, URLLC, and mMTC. The terminals/services have different requirements for the CN. For example, the eMBB service requires a high data rate while the URLLC service requires high stability and low latency. Network slicing is technology disclosed to meet such requirements.

In wireless communication systems, network slice technology enables the provision of various virtual networks that may provide specialized services. A wireless communication system may perform access control according to the degree of use of each network slice when a new UE or a protocol data unit (PDU) session attempts to access a network slice through a network slice access control function. There is a need in the art for more efficiency in the network slice technology and for a method for reducing signaling overhead when a wireless communication system performs the network slice access control.

### SUMMARY

The disclosure has been made to address at least the above-mentioned problems and/or disadvantages and to provide at least the advantages described below.

Accordingly, an aspect of the disclosure is to provide a method and device for efficiently performing network slice access control in a wireless communication system.

An aspect of the disclosure is to provide a method and device for reducing signaling overhead during network slice access control in a wireless communication system.

In accordance with an aspect of the disclosure, a method performed by an access and mobility management function (AMF) for network slice access control in a wireless communication system includes receiving a first protocol data unit (PDU) session establishment request message including information about a network slice from a UE, transmitting, to a first network entity managing a PDU session of the UE, a first generation request message for the PDU session, receiving a response message including information indicating generation failure of the PDU session from the first network entity in response to the first generation request message, and transmitting a first PDU session establishment reject message including information about a back-off timer to the UE in response to the first PDU session establishment request message. The back-off timer indicates a time until the UE transmits a second PDU session establishment request.

In accordance with an aspect of the disclosure, an AMF in a wireless communication system includes a transceiver, and a processor configured to receive, through the transceiver, a first protocol data unit (PDU) session establishment request message including information about a network slice from a UE, transmit, through the transceiver to a first network entity managing a PDU session of the UE, a first generation request message for the PDU session, receive, through the transceiver, a response message including information indicating generation failure of the PDU session from the first network entity in response to the first generation request message, and transmit, through the transceiver, a first PDU session establishment reject message including information about a back-off timer to the UE in response to the first PDU session establishment request message. The back-off timer indicates a time until the UE transmits a second PDU session establishment request.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1 illustrates a network structure for a 5G system according to an embodiment;

FIGS. 2A and 2B illustrate a network slice access control method in a wireless communication system according to an embodiment;

FIGS. 3A and 3B illustrate a network slice access control method in a wireless communication system according to an embodiment;

FIG. 4 illustrates a network slice access control method in a wireless communication system according to an embodiment; and

FIG. 5 illustrates a configuration of a network entity in a wireless communication system according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

Terms indicating a network entity or a network function and entities of an edge computing system, and terms indicating messages and identification information used in the disclosure are provided for convenience of description. Accordingly, the disclosure is not limited to the terms described below, and other terms indicating an object having an equivalent technical meaning may be used.

As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another and does not limit the components in importance or order.

As used herein, terms for identifying access nodes and denoting network entities, messages, inter-network entity interfaces, and various pieces of identification information are provided as an example for ease of description. Thus, the disclosure is not limited by the terms, and such terms may be replaced with other terms denoting objects with an equivalent technical concept.

For ease of description, the terms and names defined in the 3rd generation partnership project 5G and NR standards among the current communication standards are used herein. However, the disclosure is not limited by such terms and names and may be likewise applicable to wireless communication systems conforming to other standards such as 3GPP GS/NR (5th generation mobile communication standards).

Hereinafter, the base station may be an entity allocating resource to terminal and may be at least one of eNodeB, Node B, base station (BS), radio access network (RAN), access network (AN), RAN node, wireless access unit, base station controller, or node over network. The UE may be at least one of a terminal, a mobile station (MS), cellular phone, smartphone, computer, or multimedia device capable of performing communication functions. In the disclosure, downlink (DL) refers to a wireless transmission path of signal transmitted from the BS to the terminal, and uplink (UL) refers to a wireless transmission path of signal transmitted from the terminal to the BS. Although LTE or LTE-A system is described in connection with embodiments, as an example, embodiments may also apply to other communication systems with similar technical background or channel form. Embodiments may be modified in such a range as not to significantly depart from the scope of the disclosure under the determination by one of ordinary skill in the art and such modifications may be applicable to other communication systems.

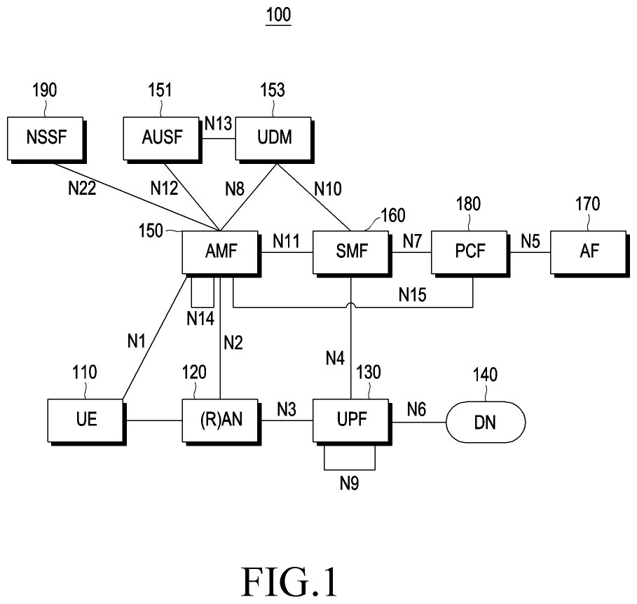

FIG. 1 illustrates a network structure for a 5G system according to an embodiment. Referring to FIG. 1, the network technology may refer to the relevant standards defined by the international telecommunication union (ITU) or 3GPP, and each of the components included in the network architecture of FIG. 1 may indicate a physical entity or software that performs an individual function or hardware combined with software. Reference numerals shown as N1, N2, N3, . . . , Nxxx indicate known interfaces between the NFs in the 5G CN.

The 5G system of FIG. 1 may include a 5G CN (5GC), a BS 120 and a UE 110. The 5GC may include an access and mobility management function (AMF) 150 for managing mobility of the UE 110, a session management function (SMF) 160 for managing the session, a user plane function (UPF) 130 connected to a data network (DN) 140 to perform a data transfer function, a network slice selection function (NSSF) 190 for selecting a network slice serving the UE 110, an authentication server function (AUSF) 151 for authenticating network entity(s) in the 5G system, a network exposure function (NEF) (not shown) for transmitting or receiving the event occurring in the 5G system and the supporting capability to the outside, a network repository function (NRF) (not shown) for managing registration information about the NFs, a policy control function (PCF) 180 for providing a policy control function of the network operator, and a user data management (UDM) 153 for providing a data management function such as of subscriber data and policy control data, a unified data repository (UDR) (not shown) storing data of various NFs such as the UDM 153, and the application function (AF) 130 that provides an application service may communicate with the 5GC.

A conceptual link connecting NFs in the 5G system is defined as a reference point. Example reference points included in the 5G system architecture represented in FIG. 1 are provided as follows.
N1 is the reference point between the UE 110 and the AMF 150.
N2 is the reference point between (R)AN 120 and AMF 150.
N3 is the reference point between (R)AN 120 and UPF 130.
N4 is the reference point between SMF 160 and UPF 130.
N5 is the reference point between PCF 180 and AF 170.
N6 is the reference point between UPF 130 and DN 140.
N7 is the reference point between SMF 160 and PCF 180.
N8 is the reference point between the UDM 153 and the AMF 150.
N9 is the reference point between two core UPF 130s.
N10 is the reference point between UDM 153 and SMF 160.
N11 is the reference point between AMF 150 and SMF 160.
N12 is the reference point between AMF 150 and AUSF 151.
N13 is the reference point between UDM 153 and authentication server function (AUSF 151).
N14 is the reference point between two AMF 150s.
N15 is the reference point between PCF 180 and AMF 150 in a non-roaming scenario and reference point between PCF 180 in visited network and AMF 150 in a roaming scenario.
N22 is the reference point between AMF 150 and NSSF 190.

FIG. 1 is a view illustrating an example of a network structure for a 5G system.

The AMF 150 is an entity for managing access and mobility of the UE 110. As an example, the AMF 150 may perform such network functions as registration of the UE 110, connection, reachability, mobility management, access identification/authentication, and mobility event generation. The SMF 160 may perform a management function for a PDU session of the UE 110. For example, the SMF 160 may perform such network functions as session management functions of establishing, modifying, or releasing a session and maintaining a tunnel between the UPF 130 and the BS 120, and the functions of allocating and managing an IP address of the UE 110, selection and control of the user plane. The UPF 130 may perform a data processing function of transferring data transmitted by the UE 110 to the DN 140, which is an external network, or transferring data received from the DN 140 to the UE 110. The UPF 130 may perform network functions, such as acting as an anchor between radio access technologies (RATs), providing connection with PDU sessions and the AF 170, packet routing and forwarding, packet inspection, application of user plane policy, creating a traffic usage report, or buffering.

The PCF 180 may manage operator policy information for providing the service in the 5G system, and the UDM 153 may perform functions such as generating authentication information for 3GPP security, managing the list of network functions NF supporting the UE 110, and managing subscription information. The 5G system supports a technology called session and service continuity (SSC) mode that supports session continuity for the purpose of improving quality-of-experience (QoE) of users or supporting mission critical services.

In FIG. 1, when the UE 110 registers with a network, the UE 110 may transmit identification information (i.e., requested S-NSSAIs) about network slices to be requested to the AMF 150, and the AMF 150 may provide the UE 110 with information (allowed NSSAI) about network slices usable by the UE 110 in consideration of the requested S-NSSAIs and subscriber information. To transmit and receive data to and from a specific data network (DN) 140 through allowed network slices (allowed NSSAIs), the UE 110 may select one of the allowed network slices, request the data network name (DNN) for the network slice to generate a PDU session, and transmit and receive data through the generated PDU session.

In the 5G system, network slicing is a technique and structure that enables several virtualized, independent, logical networks in one physical network. The network operator may configure a virtual end-to-end network called a network slice and provide service to meet specified requirements for the service/application. The network slice is identified by an identifier referred to as single-network slice selection assistance information (S-NSSAI), and the network operator provides the network slice(s) to the UE to allow the UE to receive a service.

When the UE registers in the network, the UE transmits identifier information (i.e., requested S-NSSAIs) about the network slice(s) to be requested to the AMF, and the AMF provides information (allowed NSSAI) about the network slice(s) usable by the UE to the UE considering the requested S-NSSAIs and subscriber information. Even if the UE does not provide the information about the network slice(s) requested by the UE, the AMF may provide the UE with the allowed NSSAI. In this case, the allowed NSSAI may include information about the network slice(s) set as default (i.e., default subscribed S-NSSAIs) among information about default configuration network slices (default configured NSSAI) and subscribed network slice(s) included in the UE subscriber information.

When a new UE or PDU session attempts access to the network slice through the network slice access control function in the wireless communication system (e.g., when the AMF receives a requested NSSAI from the UE), a network slice access control function (NSACF) may perform access control according to the degree of use of each network slice. In this case, the following method may be used for each network slice.

When the number of currently registered UEs for the network slice reaches the maximum number of registered UEs for the corresponding network slice, the NSACF may reject the new UE's access to the corresponding network slice. When the number of registered UEs is not reached, access to the corresponding network slice may be allowed. When the new UE requests access to a new network slice, the AMF may transmit a request message for inquiring the NSACF whether to allow access.

The NSACF may perform access control based on the number of UEs with at least one or more PDU sessions or packet data network (PDN) connections while being registered for the network slice (i.e., number of registered UEs with at least one PDU session/PDN Connection per S-NSSAI).

When the current number of registered UEs with at least one PDU session/PDN Connection per S-NSSAI for the network slice reaches the maximum value of the number of registered UEs with at least one PDU session/PDN Connection per S-NSSAI for the network slice, the NSACF may reject the new UE's access to the corresponding network slice. When the maximum value is not reached, access to the corresponding network slice may be allowed.

One NF or network entity may simultaneously support different network systems, and such NF, network node, or network entity may be referred to as the previously described combo node, combo NF, combined node, combined NF, interworking node, or interworking NF. The function of the NF exemplified as the combo node may be implemented through interworking between two or more network entities. For example, NFs simultaneously supporting different network systems may be indicated using the symbol “+” or “/”. For example, when the SMF of the 5GS and the packet data network gateway-control (PGW-C) of the evolved packet system (EPS) are configured as one combo node, the combo node may be expressed as, e.g., PGW-C/SMF, PGW-C+SMF, SMF/PGW-C, or SMF+PGW-C. When the new UE transmits a PDU session establishment request for a new network slice, SMF+PGW-C may transmit a request message for inquiring the NSACF whether to allow access to the new network slice. When the NSACF transmits a message indicating rejection, the SMF (or SMF+PGW-C) may reject the PDU session establishment request for the corresponding UE.

When the current number of PDU sessions for the network slice (i.e., number of PDU sessions per S-NSSAI) reaches the maximum value of the number of PDU sessions per S-NSSAI for the corresponding network slice, the NSACF may reject the new UE's access to the corresponding network slice. When the maximum value is not reached, the NSACF may allow access to the corresponding network slice. When the new UE transmits a PDU session establishment request for the new network slice, the SMF may transmit a request message for inquiring the NSACF whether to allow access. When the NSACF transmits a message indicating rejection, the SMF may reject the PDU session establishment request for the corresponding UE.

In FIG. 1, the NSACF may manage the following quota for each network slice through an NSAC procedure. For example, quotas such as the number of registered UEs per network slice, the number of established PDU sessions per network slice, and the number of registered UEs with at least one PDU Session/PDN Connection per network slice may be managed. In the procedure of the NSACF for the number of registered UEs per network slice, the AMF may include an increase request indicator or a decrease request indicator for the number of registered UEs for the corresponding network slice in each message transmitted to the NSACF when registering or deregistering the network slice of the UE. The NSACF may count the number of registered UEs per network slice and, when the number of registered UEs per network slice reaches a predetermined maximum value, reject the request for increasing the number of UEs for the corresponding network slice from the AMF. In the procedure of the NSACF for the number of PDU sessions per network slice, the SMF may request the NSACF to increase or decrease the number of PDU sessions per network slice when generating or releasing a PDU session for each network slice. The NSACF may count the number of PDU sessions per network slice and, when the number of PDU sessions per network slice reaches a predetermined maximum value, reject the request for increasing the number of PDU sessions for the corresponding network slice from the SMF.

In the procedure of the NSACF for the number of registered UEs with at least one PDU session or PDN connection per network slice, the SMF may include an increase request indicator or a decrease request indicator for the number of registered UEs for the corresponding network slice in each message transmitted to the NSACF during the first PDU session generation or the last PDU session release of the UE for each network slice. The NSACF may count the number of registered UEs with at least one PDU session or PDN connection per network slice and, when the number of registered UEs with at least one PDU session or PDN connection per network slice reaches a predetermined maximum value, reject the request for increasing the number of UEs for the corresponding network slice from the SMF.

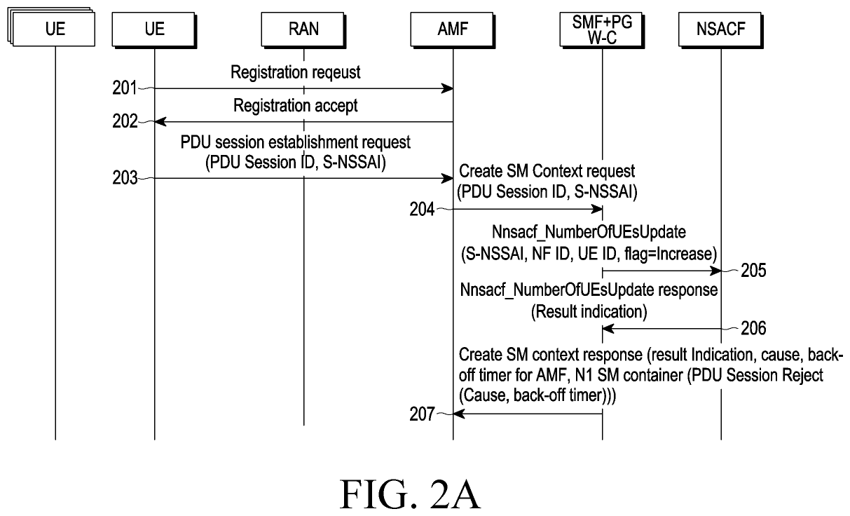

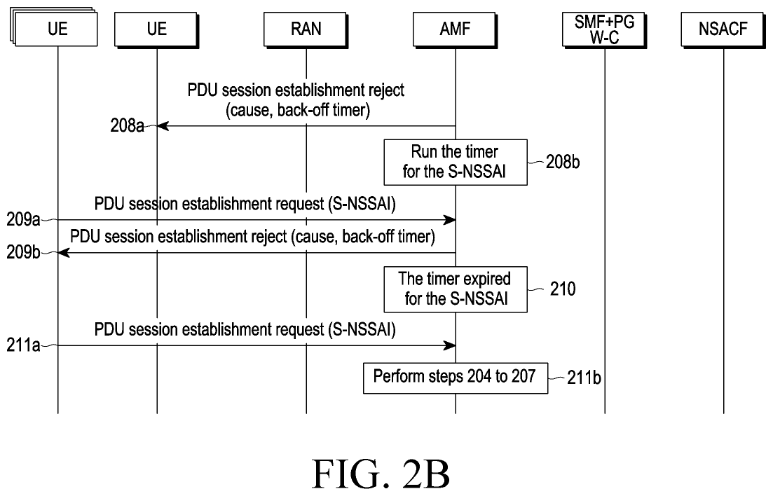

FIGS. 2A and 2B illustrate a network slice access control method in a wireless communication system according to an embodiment. Examples of FIGS. 2A and 2B show a an NSAC method based on the number of registered UEs with at least one PDU session/PDN connection per network slice (per S-NSSAI).

Referring to FIG. 2A, in step 201, the UE may transmit a registration request message to the AMF through the RAN. The registration request message may include information (e.g., requested NSSAI) about the network slice(s) for requesting registration.

In step 202, the AMF may include allowed network slice information (e.g., allowed NSSAI) in the registration accept message transmitted to the UE through the RAN.

In step 203, the UE may transmit a PDU session establishment request message including S-NSSAI (e.g., one of the S-NSSAIs included in the allowed NSSAI received in step 202), and the PDU session ID.

In step 204, the AMF may select an SMF+PGW-C. The AMF may transmit an SM context generation request for the PDU session to the selected SMF+PGW-C. The SM context generation request message may include the PDU session ID and S-NSSAI received in step 203.

In step 205, when the S-NSSAI received in step 204 is the target for EPC counting, the SMF+PGW-C, or information indicating whether it is the NSAC target in EPC per S-NSSAI, may be included in the configuration information. In the S-NSSAI which is the NSAC target in EPC, the SMF+PGW-C may perform an NSAC procedure when the UE accesses through the EPC. In the S-NSSAI supporting interworking, whether S-NSSAI supports interworking (i.e., whether it may be used in EPC) may be stored in the configuration information. When it is set as NSAC based on the number of registered UEs with at least one PDU session/PDN connection per S-NSSAI, the SMF+PGW-C may operate as follows.

Specifically, when the UE establishes the first PDU session/PDN connection associated with the corresponding S-NSSAI, the SMF+PGW-C may transmit an update request message related to network slice access control to the NSACF. The corresponding update request message may include at least one of 1-1) to 1-4) information.
1-1) UE ID: UE identifier may be included.
1-2) S-NSSAI: S-NSSAI to be updated may be included.
1-3) NF ID: ID of SMF+PGW-C may be included.
1-4)-flag: may be set as ‘increase’.

In step 206, when the flag is set as, e.g., ‘increase’ in the update request message received in step 205, the NSACF may operate as follows.

When already storing the UE ID, S-NSSAI, and NF ID received in step 205, the NSACF may include a result indication indicating the maximum number of UEs per S-NSSAI not reached or the maximum number of UEs with at least one PDU session/PDN Connection per S-NSSAI not reached in the update response message related to network slice access control transmitted to the SMF+PGW-C.

In step 206, when the UE ID, S-NSSAI, and NF ID received in step 205 are not stored in the NSACF, the NSACF may identify whether the number of registered UEs with at least one PDU session/PDN Connection per S-NSSAI for the corresponding S-NSSAI reaches the maximum value of the number of registered UEs with at least one PDU session/PDN Connection per S-NSSAI for the corresponding S-NSSAI.

When the maximum value is already reached, in step 206, the NSACF may reject the new UE's access to the corresponding network slice. In this case, the NSACF may include a result indication of the maximum number of UEs per S-NSSAI reached or the maximum number of UEs with at least one PDU session/PDN Connection per S-NSSAI reached in the response message related to network slice access control transmitted to the SMF+PGW-C.

When the maximum value is not reached, the NSACF may allow access to the corresponding network slice in step 206. In this case, the NSACF may include a result indication indicating the maximum number of UEs per S-NSSAI not reached (or maximum number of UEs with at least one PDU session/PDN Connection per S-NSSAI not reached) in the response message transmitted to the SMF+PGW-C. The NSACF may store the S-NSSAI, NF ID, and UE ID included in the message received in step 205 and increase, by one, the current number of registered UEs with at least one PDU session/PDN Connection per S-NSSAI for the corresponding S-NSSAI.

In step 207, when receiving a result indication indicating the maximum number of UEs per S-NSSAI not reached (or maximum number of UEs with at least one PDU session/PDN Connection per S-NSSAI not reached) from the NSACF in step 206, the SMF+PGW-C may transmit an SM context response message including information indicating success for the SM context generation request in step 204 to the AMF.

When receiving an update response message including a result indication indicating the maximum number of UEs per S-NSSAI reached (or maximum number of UEs with at least one PDU session/PDN Connection per S-NSSAI reached) in step 206, the SMF+PGW-C may transmit, to the AMF, an SM context response message indicating failure for the SM context generation request in step 204. For example, the SM context response message may include at least one of 2-1) to 2-4) information.
2-1) result indication: A result indication indicating failure for the SM context generation request may be included.
2-2) cause: One of the cause value indicating S-NSSAI congestion, the cause value indicating shortage of S-NSSAI resources, and the cause value indicating that the S-NSSAI has been rejected due to the NSAC may be included.
2-3) Back-off timer for AMF: Back-off timer that may be used by the AMF may be included. This value may be the same value as the back-off timer included in the N1 SM container.
2-4) N1 SM Container (PDU Session reject (cause, back-off timer))

Referring to FIG. 2B, in step 208a, when the N1 SM container is included in the SM context response message received in step 207 (e.g., N1 SM container including PDU session reject), the AMF may transmit a PDU session establishment reject message including information indicating the PDU session reject (cause, back-off timer) to the UE through the RAN. When the back-off timer is not included in the SM context response message received in step 207, the AMF may include the back-off timer in the PDU session reject message based on the configuration information. In this case, the AMF may set the back-off timer to be included in the session establishment reject message based on the back-off timer for AMF included in the SM context response message of step 207 or the back-off timer included in the configuration information (e.g., a timer selected from at least one timer value that may be set as the back-off timer for the UE or the back-off timer for AMF).

In step 208a, the UE may receive a message including information indicating PDU session reject and, when the corresponding message includes the back-off timer, start the back-off timer and may not transmit a PDU session establishment request message associated with the corresponding S-NSSAI until the back-off timer expires. If the corresponding back-off timer expires (i.e., if the received back-off timer time elapses), the UE may transmit a PDU session establishment request message associated with the corresponding S-NSSAI.

In step 208b, when the SM context response message received in step 207 includes at least one of the result indication indicating failure, the cause value indicating S-NSSAI congestion, shortage of S-NSSAI resources, or that the S-NSSAI has been rejected due to the NSAC, and when the SM context response message of step 207 does not include the back-off timer for AMF, the AMF may start the timer in which the back-off timer stored as the configuration information for the corresponding S-NSSAI (e.g., the S-NSSAI for the message of step 204 or step 207) is set as an expiration value. When the SM context response message of step 207 includes the back-off timer for AMF, the AMF may set the value of the back-off timer for AMF, instead of the back-off timer stored in the configuration information, as the expiration value of the timer and start the corresponding timer.

In step 209a and step 209b, when the timer for the S-NSSAI which the AMF starts in step 208b (i.e., the back-off timer for AMF) does not expire, and when the PDU session establishment request message including the corresponding S-NSSAI is received from the UE(s), the AMF may transmit a PDU session establishment reject message to the UE(s), and may not transmit an SM context generation request message to the SMF+PGW-C. In this case, the PDU session establishment reject message may include the cause, back-off timer information as in step 208a. In this case, the AMF may set the back-off timer to be included in the session establishment reject message based on the back-off timer for AMF included in the SM context response message of step 207 or the back-off timer included in the configuration information (e.g., a timer selected from at least one timer value that may be set as the back-off timer for the UE or the back-off timer for AMF). In step 210, the timer which the AMF starts in step 208b may expire.

In step 211a, when the timer for the S-NSSAI which the AMF starts in step 208b expires, and when the PDU session establishment request message including the corresponding S-NSSAI is received from the UE(s), step 211b is performed at the AMF. Specifically, in a series of operations in which in steps 204 to 207, the AMF transmits an SM context generation request message and receives an SM context response message in response thereto may be performed (i.e., the AMF transmits a create SM context message to the SMF+PGW-C). The AMF may transmit a PDU session establishment accept or PDU session establishment reject to each UE according to the message received from the SMF+PGW-C.

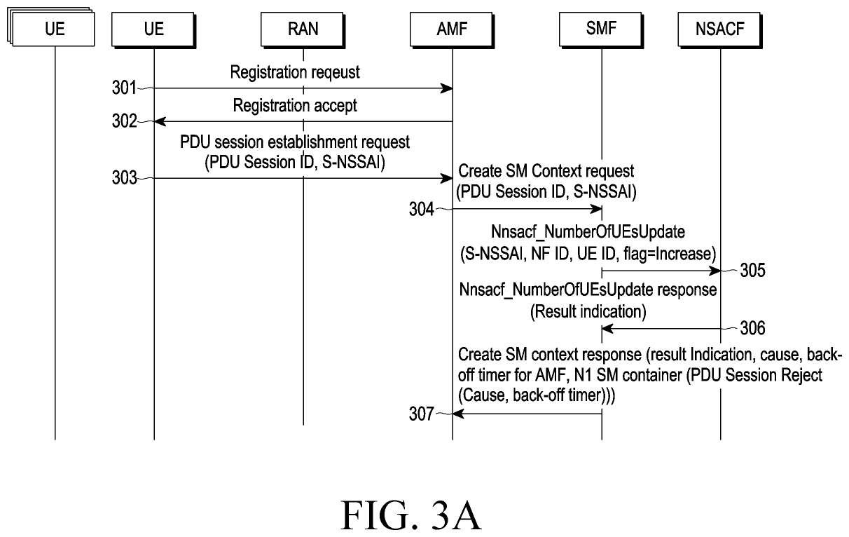

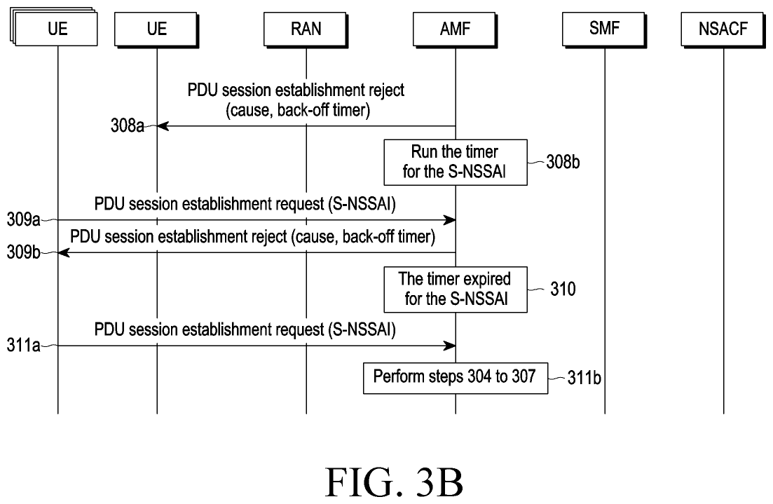

FIGS. 3A and 3B illustrate a network slice access control method in a wireless communication system according to an embodiment. The examples of FIGS. 3A and 3B show an NSAC method based on the number of PDU sessions per S-NSSAI.

Referring to FIG. 3A, in step 301, the UE may transmit a registration request message to the AMF through the RAN. The registration request message may include information (e.g., requested NSSAI) about the network slice(s) for requesting registration.

In step 302, the AMF may include allowed network slice information (e.g., allowed NSSAI) in the registration accept message transmitted to the UE through the RAN.

In step 303, the UE may transmit a PDU session establishment request message to the AMF, including S-NSSAI (e.g., one of the S-NSSAIs included in the allowed NSSAI received in step 302), and the PDU session ID.

In step 304, the AMF may select an SMF. The AMF may transmit an SM context generation request for the PDU session to the selected SMF. The SM context generation request message may include the PDU session ID and S-NSSAI.

In step 305, the SMF may operate as follows when the S-NSSAI received in step 304 is set as the NSAC based on the number of PDU sessions per S-NSSAI.

Specifically, when the UE establishes the PDU session associated with the corresponding S-NSSAI, the SMF may transmit an update request message related to network slice access control to the NSACF. The corresponding update request message may include at least one of 3-1) to 3-4) information.
3-1) UE ID: UE identifier may be included.
3-2) S-NSSAI: S-NSSAI to be updated may be included.
3-3) NF ID: ID of SMF may be included.
3-4) flag: may be set as ‘increase’.

In step 306, when the flag is set as, e.g., ‘increase’ in the update request message received in step 305, the NSACF may operate as follows.

When already storing the UE ID, S-NSSAI, and NF ID received in step 305, the NSACF may include a result indication indicating the maximum number of PDU sessions per S-NSSAI not reached in the update response message related to network slice access control transmitted to the SMF.

In step 306, when the UE ID, S-NSSAI, and NF ID received in step 305 are not stored in the NSACF, the NSACF may identify whether the current number of PDU sessions per network slice for the corresponding S-NSSAI reaches the number of PDU sessions per S-NSSAI for the corresponding S-NSSAI.

When the maximum value is already reached, in step 306, the NSACF may reject the new UE's access to the corresponding network slice. In this case, the NSACF may include the result indication indicating that the number of PDU sessions per network slice reaches the maximum value in the response message related to network slice access control transmitted to the SMF.

When the maximum value is not reached, the NSACF may allow access to the corresponding network slice in step 306. In this case, the NSACF may include the result indication indicating the maximum number of PDU sessions per S-NSSAI not reached in the response message transmitted to the SMF. The NSACF may store the S-NSSAI, NF ID, and UE ID included in the message received in step 305 and increase, by one, the current number of PDU sessions per network slice for the corresponding S-NSSAI.

In step 307, when receiving a result indication indicating the maximum number of PDU sessions per S-NSSAI not reached from the NSACF in step 306, the SMF may transmit an SM context response message including information indicating success for the SM context generation request in step 304 to the AMF.

When receiving an update response message including a result indication indicating the maximum number of PDU sessions per S-NSSAI reached in step 306, the SMF may transmit, to the AMF, an SM context response message indicating failure for the SM context generation request in step 304. For example, the SM context response message may include at least one of 4-1) to 4-4) information.
4-1) result indication: A result indication indicating failure may be included.
4-2) cause: One of the cause value indicating S-NSSAI congestion, the cause value indicating shortage of S-NSSAI resources, and the cause value indicating that the S-NSSAI has been rejected due to the NSAC may be included.
4-3) Back-off timer for AMF: Back-off timer that may be used by the AMF may be included. This value may be the same value as the back-off timer included in the NI SM container.
4-4) N1 SM Container (PDU Session reject (cause, back-off timer))

Referring to FIG. 3B, in step 308a, when the N1 SM container is included in the SM context response message received in step 307 (e.g., N1 SM container including PDU session reject), the AMF may transmit a PDU session establishment reject message including information indicating the PDU session reject (cause, back-off timer) to the UE through the RAN. When the back-off timer is not included in the SM context response message received in step 307, the AMF may include the back-off timer in the PDU session reject message based on the configuration information. In this case, the AMF may set the back-off timer to be included in the session establishment reject message based on the back-off timer for AMF included in the SM context response message of step 307 or the information stored in the configuration information (e.g., a timer selected from at least one timer value that may be set as the back-off timer for the UE or the back-off timer for AMF).

In step 308a, the UE may receive a message including information indicating PDU session reject and, when the corresponding message includes the back-off timer, start the back-off timer and may not transmit a PDU session establishment request message associated with the corresponding S-NSSAI until the back-off timer expires. If the corresponding back-off timer expires (i.e., if the received back-off timer time elapses), the UE may transmit a PDU session establishment request message associated with the corresponding S-NSSAI.

In step 308b, when the SM context response message received in step 307 includes at least one of the result indication indicating failure, or the cause value indicating S-NSSAI congestion, shortage of S-NSSAI resources, or that the S-NSSAI has been rejected due to the NSAC, and when the SM context response message of step 307 does not include the back-off timer for AMF, the AMF may start the timer in which the back-off timer stored as the configuration information for the corresponding S-NSSAI (e.g., the S-NSSAI for the message of step 304 or step 307) is set as an expiration value. When the SM context response message of step 307 includes the back-off timer for AMF, the AMF may set the value of the back-off timer for AMF, instead of the back-off timer stored in the configuration information, as the expiration value of the timer and start the corresponding timer.

In step 309a and step 309b, when the timer for the S-NSSAI which the AMF starts in step 308b does not expire, and when the PDU session establishment request message including the corresponding S-NSSAI is received from the UE(s), the AMF may transmit a PDU session establishment reject message to the UE(s), and may not transmit an SM context generation request message to the SMF+PGW-C. In this case, the PDU session establishment reject message may include the cause, back-off timer information as in step 208a. In this case, the AMF may set the back-off timer to be included in the session establishment reject message based on the back-off timer for AMF included in the SM context response message of step 307 or the back-off timer included in the configuration information (e.g., a timer selected from at least one timer value that may be set as the back-off timer for the UE or the back-off timer for AMF).

In step 310, the timer which the AMF starts in step 308b may expire.

In step 311a, when the timer for the S-NSSAI which the AMF starts in step 308b expires, and when the PDU session establishment request message including the corresponding S-NSSAI is received from the UE(s), step 311b is performed. Specifically, a series of operations in which in steps 304 to 307, the AMF transmits an SM context generation request message and receives an SM context response message in response thereto may be performed (i.e., the AMF transmits a create SM context message to the SMF). The AMF may transmit a PDU session establishment accept or PDU session establishment reject to each UE according to the message received from the SMF.

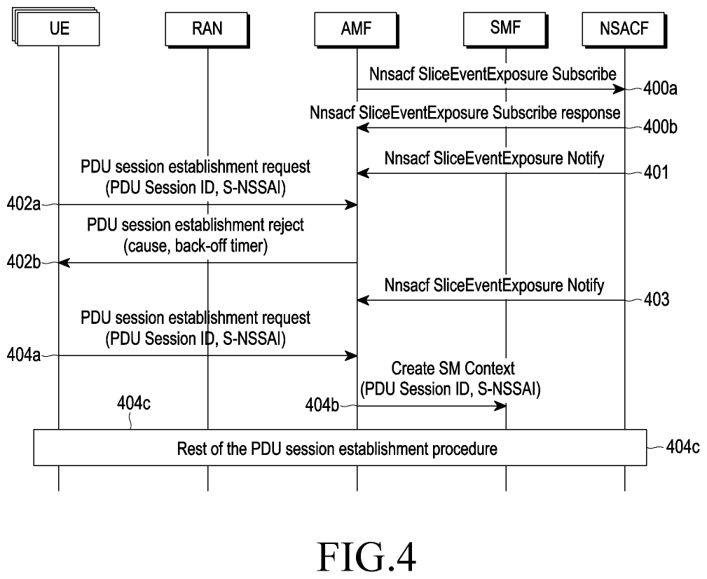

FIG. 4 illustrates a network slice access control method in a wireless communication system according to an embodiment. The example of FIG. 4 shows an AMF-based PDU session reject method through an NSACF event subscription.

Referring to FIG. 4, in step 400a, the AMF may transmit a subscription request message for state information for the S-NSSAI to the NSACF. The corresponding subscription request message may include at least one of 5-1) to 5-4) information.
5-1) Event ID: One or more of the number of UEs registered with a network slice, the number of registered UEs with at least one PDU session/PDN connection for a network slice, the number of PDU sessions established on a network slice may be included.
5-2) Event Filter: The target S-NSSAI where state information (e.g., the number of registered UEs, the number of sessions) notification is to be received may be included.
5-3) Event Reporting information: may indicate the threshold-based notification or periodical notification.
5-4) notification threshold: When the event reporting information is a threshold-based notification, a threshold value may be included. The threshold value may be a numeric value or percentage. When desiring to receive a notification for when the number of registered UEs for the network slice reaches a specific value, the AMF may set the threshold value as the corresponding value. When desiring to receive a notification for when the number of registered UEs for the network slice reaches the maximum value, the AMF may set the threshold value as the maximum value or set the threshold value as a predefined value indicating the maximum.

When desiring to receive a notification for when the number of registered UEs with at least one PDU session/PDN connection for the network slice reaches a specific value, the AMF may set the threshold value as the corresponding value. When desiring to receive a notification for when the number of registered UEs with at least one PDU session/PDN connection for the network slice, the AMF may set the threshold value as the maximum value or set the threshold value as a predefined value indicating the maximum.

When desiring to receive a notification for when the number of PDU sessions for the network slice reaches a specific value, the AMF may set the threshold value as the corresponding value. When desiring to receive a notification for when the number of PDU sessions for the network slice reaches the maximum value, the AMF may set the threshold value as the maximum value or set the threshold value as a predefined value indicating the maximum.

In step 400b, the NSACF may transmit a response message to the subscription request message of step 400a to the AMF. The corresponding response message may include information (e.g., success or failure in the subscription request) indicating the result and notification correlation information (i.e., which may include, e.g., identification information for identifying the subscription information generated by the subscription request message transmitted by the AMF in step 400a). The notification correlation information indicates correlation information about the notification.

In step 401, when receiving a request for a threshold-based notification for the number of registered UEs with at least one PDU session/PDN connection of the S-NSSAI from the AMF in step 400a, when receiving a threshold, and when the number of registered UEs with at least one PDU session/PDN connection reaches the corresponding threshold (e.g., a threshold for the percent indicating the current value relative to the maximum value or a threshold for the current numeric value), the NSACF may transmit a notification message for indicating the threshold-based notification to the AMF. The corresponding notification message may include at least one of 6-1) to 6-4) information.
6-1) Event ID: The event ID to which the notification corresponds among the same information as the event ID included in the message of step 400a may be included. For example, the event ID may include the value indicating the number of registered UEs or the number of PDU sessions.
6-2) Event Filter: The S-NSSAI to which the notification is applied may be included.
6-3) Event reporting information: Network slice status information may be included. When information for the number of registered UEs with at least one PDU session/PDN connection is included, an indication thereof may be included.
6-4) Notification Correlation Information: Correlation information for the notification may be included.

When the message transmitted from the NSACF to the AMF in step 401 is a notification message transmitted due to the threshold-based notification, and the threshold is set as a predefined value indicating the maximum value (e.g., when event ID is the number of registered UEs, and the notification information includes an indication indicating the number of registered UEs with at least one PDU session/PDN Connection, the maximum value for the number of registered UEs with at least one PDU session/PDN Connection), the NSACF may include information indicating that the threshold has reached the maximum value or may include a predefined value indicating the maximum value or the maximum value itself.

The notification correlation information included in the response message transmitted from the NSACF to the AMF in step 400b may also be included in the notification message of step 401.

In steps 402a and 402b, the AMF may receive the notification message of step 401 and, when the corresponding notification message includes information indicating that the number of registered UEs with at least one PDU session/PDN connection for the S-NSSAI reaches the maximum value or 100% (or a predefined threshold value), or includes information indicating that the number of PDU sessions for the S-NSSAI reaches the maximum value or 100% (or a predefined threshold value), if receiving a PDU session establishment request including the corresponding S-NSSAI from the UE(s) later, the AMF may transmit a message including the PDU session establishment reject for the corresponding UE(s). The corresponding PDU session establishment reject message may include a cause (e.g., the maximum number of UEs with at least one PDU session/PDN Connection is reached (or exceeded), maximum number of PDU session is reached (or exceeded)) and the back-off timer. The AMF may perform the corresponding determination based on the operator's policy or configuration information.

In step 403, when the number of registered UEs with at least one PDU session/PDN connection for the S-NSSAI decreases to a value lower than the maximum value or 100% (or a lower-threshold value), the NSACF may transmit, to the AMF, a notification message including information indicating that the corresponding value does not reach the maximum value or the threshold or information indicating that the corresponding percent value does not reach 100% or the threshold. When the NSACF includes information indicating that the number of PDU sessions for the S-NSSAI reaches the maximum value or 100% (or a lower-threshold value) in the notification message transmitted to the AMF in step 401, if the number of PDU sessions for the corresponding S-NSSAI decreases to a value lower than the maximum value or 100% (or a lower-threshold value) later, the NSACF may transmit, to the AMF, a notification message including information indicating that the corresponding value does not reach the maximum value or the threshold or information indicating that the corresponding percent value does not reach 100% or the threshold. In this case, the lower-threshold value may be received from the AMF or may be a threshold set on its own.

Thereafter, in steps 404a to 404c, the AMF may transmit an SM context generation request message to the SMF if receiving, from the UE(s), a PDU session establishment request for the corresponding S-NSSAI after the self-set timer value for the corresponding S-NSSAI expires after receiving a message including information indicating that the number of registered UEs with at least one PDU session/PDN connection for the S-NSSAI reaches the maximum value or 100% (or the threshold value) or information indicating that the number of PDU sessions for the S-NSSAI reaches the maximum value or 100% (or the threshold value) in step 401 or receiving the message of step 403 (i.e., a message including information indicating that the number of registered UEs with at least one PDU session/PDN connection for the S-NSSAI does not reach the threshold or the maximum value or a message including information indicating that the number of PDU sessions for the S-NSSAI does not reach the threshold or the maximum value). Thereafter, the remaining PDU session establishment procedure may be performed.

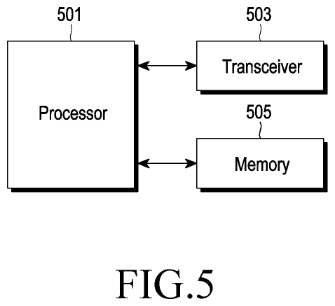

FIG. 5 illustrates a configuration of a network entity in a wireless communication system according to an embodiment.

The network entity of FIG. 5 may be one of network entities as the NSACF, SMF+PGW-C, SMF, AMF, and UE described in connection with the embodiments of FIGS. 1 to 4.

As shown in FIG. 5, the network entity may include a processor 501, a transceiver 503, and memory 505. The processor 501, transceiver 503, and memory 505 of the network entity may be operated according to the communication methods of the network entity described above in connection with the embodiments of FIGS. 1 to 4. However, the components of the network entity are not limited thereto. For example, the network entity may include more or fewer components than the above-described components. The processor 501, the transceiver 503, and the memory 505 may be implemented in the form of a single chip.

The transceiver 503 collectively refers to the receiver of the network entity and the transmitter of the network entity and may transmit and receive signals to/from a UE or another network entity. The transmitted/received signals may include at least one of control information and data. To that end, the transceiver 503 may include a wired/wireless transceiver and may include various components for transmitting/receiving signals. The transceiver 503 may receive signals through a predetermined communication interface, output the signals to the processor 501, and transmit the signals output from the processor 501. When the network entity of FIG. 5 is a UE, the transceiver 503 may include an RF transmitter for frequency-up converting and amplifying signals transmitted and an RF receiver for low-noise amplifying signals received and frequency-down converting the frequency of the received signals. The transceiver 503 may receive the communication signal and output it to the processor 501 and transmit the signal output from the processor 501 to the UE or another network entity through the network. The memory 505 may store programs and data necessary for the operation of the network entity according to at least one of the embodiments of FIGS. 1 to 4. The memory 505 may store control information or data that is included in the signal obtained by the network entity. The memory 505 may include a storage medium, such as ROM, RAM, hard disk, CD-ROM, and DVD, or a combination of storage media.

The processor 501 may control a series of processes so that the network entity may operate according to at least one of the embodiments of FIGS. 1 to 4. The processor 501 may include at least one processor. The methods according to the embodiments described in the specification may be implemented in hardware, software, or a combination of hardware and software. When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included. The programs may be stored in attachable storage devices that may be accessed via a communication network, such as the Internet, Intranet, local area network (LAN), wide area network (WAN), or storage area network (SAN) or a communication network configured of a combination thereof. The storage device may connect to the device that performs embodiments via an external port. A separate storage device over the communication network may be connected to the device that performs embodiments.

It should be appreciated that the blocks in each flowchart and combinations of the flowcharts herein may be performed by computer program instructions.

Each block may represent a module, segment, or part of a code including one or more executable instructions for executing a specified logical function(s). In some embodiments, the functions mentioned in the blocks may occur in different orders. For example, two blocks that are consecutively shown may be performed substantially simultaneously or in a reverse order depending on corresponding functions.

As used herein, the term unit indicates a software element or a hardware element such as a field-programmable gate array (FPGA) or an application specific integrated circuit (ASIC). A unit plays a certain role. However, unit is not limited to software or hardware and may be configured in a storage medium that may be addressed or may be configured to execute one or more processors. Accordingly, as an example, a unit includes elements, such as software elements, object-oriented software elements, class elements, and task elements, processes, functions, attributes, procedures, subroutines, segments of program codes, drivers, firmware, microcodes, circuits, data, databases, data architecture, tables, arrays, and variables. Functions provided within the components and the units may be combined into smaller numbers of components and units or further separated into additional components and units. The components and units may be implemented to execute one or more CPUs in a device or secure multimedia card. According to embodiments, a . . . unit may include one or more processors.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a network function (NF) for network slice access control in a wireless communication system, the method comprising:
transmitting, to a network slice admission control function (NSACF), an event exposure subscribe message including information about a status of single network slice selection assistance information (S-NSSAI);
receiving, from the NSACF, an event exposure subscribe response message indicating a result about subscription;
receiving, from the NSACF, an event exposure notify message including information about event information.

2. The method of claim 1,
wherein the event exposure notify message includes at least one of Event ID, Event Filter or Event reporting information.

3. The method of claim 1,
wherein the event exposure notify message includes information on a number of user equipments (UEs) with at least one protocol data unit (PDU) Session or packet data network (PDN) Connection.

4. The method of claim 1, further comprising:
receiving a first protocol data unit (PDU) session establishment request message including information about a network slice from a UE;
transmitting, to a first network entity managing a PDU session of the UE, a first generation request message for the PDU session;
receiving a response message including information indicating generation failure of the PDU session from the first network entity in response to the generation request message; and
transmitting a first PDU session establishment reject message including information about a back-off timer to the UE in response to the first PDU session establishment request message,
wherein the back-off timer indicates a time until the UE transmits a PDU session establishment request again.

5. The method of claim 4,
wherein each of the response message and the PDU session establishment reject message includes one of a cause value indicating S-NSSAI congestion, a cause value indicating shortage of an S-NSSAI resource, and a cause value indicating that an S-NSSAI is rejected due to network slice access control (NSAC).

6. The method of claim 4,
wherein in the first PDU session establishment reject message, the back-off timer is set based on back-off timer information included in the response message or configuration information about the NF.

7. The method of claim 4, further comprising:
starting the back-off timer; and
transmitting a second PDU session establishment reject message to the UE when a second PDU session establishment request message is received from the UE while the back-off timer is driven.

8. The method of claim 4, further comprising:
starting the back-off timer; and
transmitting a second generation request message for the PDU session to the first network entity when a second PDU session establishment request message is received from the UE after the back-off timer expires.

9. The method of claim 4,
wherein the first network entity is an SMF+PGW-C which is a combo node of a session management function (SMF) of a 5G system (5GS) and a packet data network gateway-control (PGW-C) of an evolved packet system (EPS) or the SMF.

10. A network function (NF) in a wireless communication system, comprising:
a transceiver; and
a processor configured to:
transmit, through the transceiver, an event exposure subscribe message including information about a status of single network slice selection assistance information (S-NSSAI) to a network slice admission control function (NSACF);
receive, through the transceiver, an event exposure subscribe response message indicating a result about subscription, from the NSACF;
receive, through the transceiver, an event exposure notify message including information about event information from the NSACF.

11. The NF of claim 10,
wherein the event exposure notify message includes at least one of Event ID, Event Filter or Event reporting information.

12. The NF of claim 10,
wherein the event exposure notify message includes information on a number of user equipments (UEs) with at least one protocol data unit (PDU) Session or packet data network (PDN) Connection.

13. The NF of claim 10, further comprising:
receive, through the transceiver, a first protocol data unit (PDU) session establishment request message including information about a network slice from a UE;
transmit, through the transceiver to a first network entity managing a PDU session of the UE, a first generation request message for the PDU session;
receive, through the transceiver, a response message including information indicating generation failure of the PDU session from the first network entity in response to the generation request message; and
transmit, through the transceiver, a first PDU session establishment reject message including information about a back-off timer to the UE in response to the first PDU session establishment request message,
wherein the back-off timer indicates a time until the UE transmits a PDU session establishment request again.

14. The NF of claim 13,
wherein each of the response message and the PDU session establishment reject message includes one of a cause value indicating S-NSSAI congestion, a cause value indicating shortage of an S-NSSAI resource, and a cause value indicating that an S-NSSAI is rejected due to network slice access control (NSAC).

15. The NF of claim 13,
wherein the processor is configured to set the back-off timer in the first PDU session establishment reject message based on back-off timer information included in the response message or configuration information about the NF.

16. The NF of claim 13,
wherein the processor is configured to start the back-off timer and transmit, through the transceiver, a second PDU session establishment reject message to the UE when a second PDU session establishment request message is received from the UE while the back-off timer is driven.

17. The NF of claim 13,
wherein the processor is configured to start the back-off timer and transmit, through the transceiver, a second generation request message for the PDU session to the first network entity when a second PDU session establishment request message is received from the UE after the back-off timer expires.

18. The NF of claim 13,
wherein the first network entity is an SMF+PGW-C which is a combo node of a session management function (SMF) of a 5G system (5GS) and a packet data network gateway-control (PGW-C) of an evolved packet system (EPS) or the SMF.
